(19) United States
(12) Patent Application Publication
(10) Pub. No.: US 2009/0262373 A1
(43) Pub. Date: Oct. 22, 2009

(54) METHOD OF CALCULATING CORRECTION VALUE AND LIQUID EJECTING APPARATUS

(75) Inventors: Toru TAKAHASHI, Matsumoto-shi (JP); Toru MYAMOTO, Shiojiri-shi (JP); Hirokazu KASAHARA, Okaya-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/424,754

(22) Filed: Apr. 16, 2009

(30) Foreign Application Priority Data
Apr. 16, 2008 (JP) 2008-107242

(51) Int. Cl. G06F 15/00; G06K 9/00

(52) U.S. Cl. 358/1.9; 382/167

(57) ABSTRACT

A method of calculating a correction value includes forming a correction pattern on a medium in a yellow color, acquiring blue color information by reading out the correction pattern, and calculating a correction value of the density of the yellow color based on the blue color information.

### BACKGROUND

1. Technical Field

The invention relates to a method of calculating a correction value and a liquid ejecting apparatus.

2. Related Art

When an image is formed on a medium (for example, a paper sheet) by a printing apparatus such as an ink jet printer, there is a case where non-uniformity in the shape of a stripe occurs in the image. Thus, a method in which correction patterns are printed for each color of ink by using the printing apparatus, the correction patterns are read out by a scanner or the like, and correction of the density is performed by calculating a correction value based on color information acquired as the result of reading out the correction patterns has been used (for example, see JP-A-2005-205691).

The scanner that reads out the correction patterns has sensors that acquire color information (for example, gray scales) of each color such as a red color (R), a green color (G), and a blue color (B). The scanner reads out the color information of R, G, and B of the correction pattern by using the sensors. Generally, when correction for the non-uniformity of density is performed, a correction value is acquired based on gray color information that is an average value {(R+G+B)/3} of R, G, and B, regardless of the color of ink.

However, there is a type of ink that has low variation of the gray color information with respect to the amount of ejection of ink (for example, yellow ink). In such a case, as described later, there is a problem that the influence of an error (read-out error) in reading out the correction patterns can be received easily. Accordingly, there is a problem that the accuracy of correction may be decreased.

### SUMMARY

An advantage of some aspects of the invention is that it provides a method of calculating a correction value and a liquid ejecting apparatus capable of improving the accuracy of correction.

According to a major aspect of the invention, there is provided a method of calculating a correction value. The method includes: forming a correction pattern on a medium in a yellow color; acquiring blue color information by reading out the correction pattern; and calculating a correction value of the density of the yellow color based on the blue color information.

Other aspects of the invention will become apparent by descriptions here and the accompanied drawings.

### BRIEF DESCRIPTION OF THE DRAWINGS

The invention will be described with reference to the accompanying drawings, wherein like numbers reference like elements.

FIG. 1 is a block diagram showing the configuration of a printing system 100 according to an embodiment of the invention.

FIG. 2 is a perspective view for describing a transport process and a dot forming process in a printer according to an embodiment of the invention.

FIG. 3 is an explanatory diagram of the arrangement of a plurality of heads according to an embodiment of the invention.

FIG. 4 is an explanatory diagram for briefly describing the disposition of the heads and appearance of dot formation.

FIG. 5 is an explanatory diagram showing a process performed by a printer driver according to an embodiment of the invention.

FIG. 6A is a diagram showing a form for a case where raster lines are formed ideally.

FIG. 6B is a diagram showing a form for a case where non-uniformity of density occurs.

FIG. 6C is a diagram showing a form in which the occurrence of the non-uniformity of density is suppressed.

FIG. 7 is a diagram showing the flow of a correction value acquiring process according to an embodiment of the invention.

FIG. 8 is an explanatory diagram of a correction pattern CP according to an embodiment of the invention.

FIG. 9 is a graph showing calculated densities for raster lines of sub patterns CSP according to an embodiment of the invention.

FIG. 10A is an explanatory diagram for the sequence for calculating a density correction value H that is used for correcting a directed gray scale value Sb of the i-th raster line.

FIG. 10B is an explanatory diagram for the sequence for calculating a density correction value H that is used for correcting a directed gray scale value Sb of the j-th raster line.

FIG. 11 is a diagram showing a correction value table according to an embodiment of the invention.

FIGS. 12A, 12B, and 12C are diagrams showing relationship between a gray scale of a correction pattern CP and a read-out result of a scanner 120 according to an embodiment of the invention. FIG. 12A is a diagram showing the read-out result of the correction pattern CP of a cyan color, FIG. 12B is a diagram showing the read-out result of the correction pattern CP of a magenta color, and FIG. 12C is a diagram showing the read-out result of the correction pattern CP of a yellow color.

FIG. 13 is a diagram showing the relationship between each color of ink and the dynamic range of color information of each color.

FIG. 14 is a diagram showing correspondence relationship of each color of ink and selected color information according to a first embodiment of the invention.

FIG. 15 is a diagram for describing complementary colors.

FIG. 16 is an explanatory diagram showing the color information of each color of each sub pattern CSP and calculated results of inclinations of gray scales (sub patterns).

FIG. 17 is a diagram showing a smallest value of the color information of each color (R, G, B, and gray) among the inclinations of gray scales.

FIG. 18 is a diagram showing correspondence relationship between each color of ink and selected color information according to a second embodiment of the invention.

FIG. 19 is a diagram for describing dynamic ranges and the normalization thereof.

FIG. 20 is a diagram for describing the amount of change in an inter-gray scale inclination and the normalization thereof.

FIG. 21 is a diagram showing the result of weighted calculation.

FIG. 22 is a diagram showing correspondence relationship of each color of ink and selected color information according to a third embodiment of the invention.

### DESCRIPTION OF EXEMPLARY EMBODIMENTS

### Overview of Disclosure

By descriptions here and the accompanied drawings, at least the followings become apparent.

According to a first aspect of the invention, there is provided a correction value calculating apparatus including a correction pattern forming unit that forms a correction pattern on a medium in a first color, a correction pattern reading unit that acquires color information of a second color that is a complementary color of the first color by reading out the correction pattern, and a correction value calculating unit that calculates a correction value of the density of the first color based on the color information of the second color.

According to the above-described correction value calculating apparatus, the accuracy of correction can be improved.

According to a second aspect of the invention, there is provided a correction value calculating apparatus including a correction pattern forming unit that forms a correction pattern on a medium in a yellow color, a correction pattern reading unit that acquires color information of a blue color by reading out the correction pattern, and a correction value calculating unit that calculates a correction value of the density of the yellow color based on the color information of the blue color.

According to the above-described correction value calculating apparatus, the influence of an error in reading out the correction pattern of the yellow color can be reduced, and thereby accuracy of correction can be improved.

In the above-described correction value calculating apparatus, it is preferable that the correction pattern forming unit forms sub patterns of a plurality of gray scales of the yellow color on the medium as the correction pattern, and the correction pattern reading unit acquires the color information of the blue color for each sub pattern of the plurality of gray scales.

In such a case, the accuracy of correction for the gray scales of the yellow color can be improved.

In the above-described correction value calculating apparatus, it is preferable that the correction pattern forming unit forms the sub pattern of a specific gray scale and the sub pattern of a different gray scale on the medium, and the correction value calculating unit calculates a correction value of the density of the yellow color for forming the specific gray scale based on the color information of the blue color read out from the sub pattern of the specific gray scale and the color information of the blue color read out from the sub pattern of the different gray scale.

In such a case, the variation of the correction values can be suppressed.

In the above-described correction value calculating apparatus, it is preferable that the correction pattern forming unit has a head in which a plurality of nozzles for ejecting liquid of the yellow color is formed, and the correction patterns are formed by the liquid ejected on the medium from the plurality of nozzles of the head.

In such a case, the variation of the liquid ejecting characteristics of the nozzles can be reduced.

According to a third aspect of the invention, there is provided a method of calculating a correction value. The method includes: forming a correction pattern on a medium in a yellow color; acquiring blue color information by reading out the correction pattern; and calculating a correction value of the density of the yellow color based on the blue color information.

### Printing System

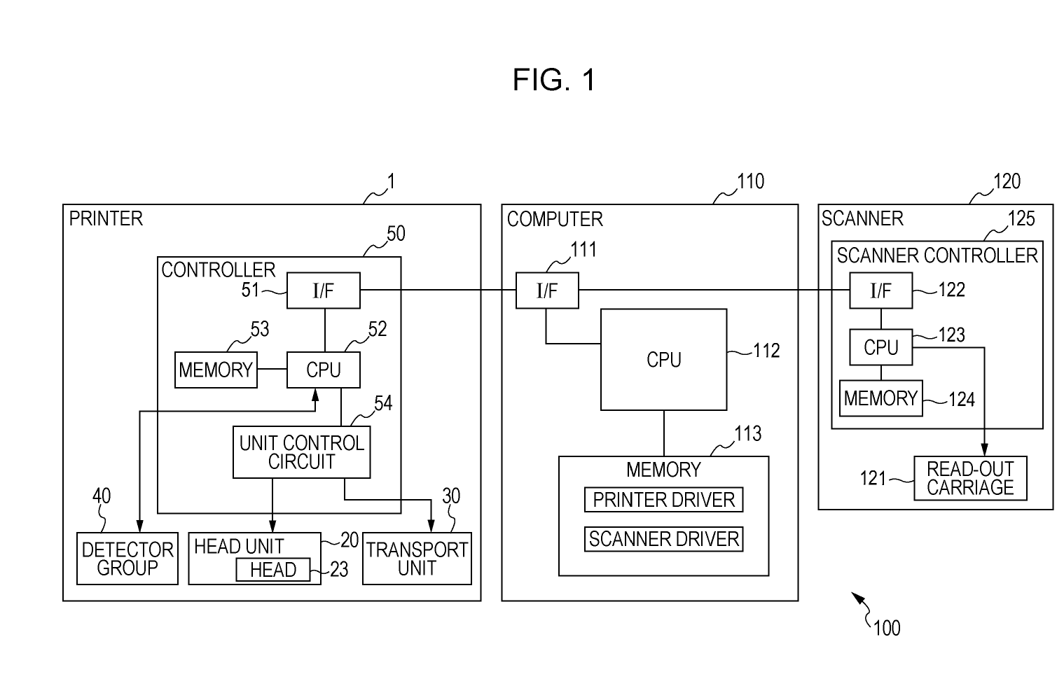

In describing non-uniformity of the density of an image and a method of suppressing the non-uniformity of density, first, a printing system 100 that is used for forming an image on a medium will be described with reference to FIG. 1. FIG. 1 is a block diagram showing the configuration of the printing system 100.

The printing system 100 according to this embodiment, as shown in FIG. 1, includes a printer 1, a computer 110, and a scanner 120.

The printer 1 is a liquid ejecting apparatus that forms (prints) an image on a medium by ejecting ink as liquid onto the medium. In this embodiment, the printer 1 is a color ink jet printer. The printer 1 can print an image on a plurality of types of media (hereinafter, referred to as a printing medium) such as a paper sheet, a texture, and a film sheet.

The computer 110 is connected to the printer 1 through an interface 111 so as to be communicatable. The computer 110 outputs print data corresponding to an image to the printer 1 for having the image to be printed by the printer 1. The computer 110 includes a CPU 112 that is used for executing various programs installed to the computer 110 and a memory 113 that stores the various programs. Among the programs installed to the computer 110, there are a printer driver that is used for converting the image data output from an application program into print data and a scanner driver that is used for controlling the scanner 120 that is connected to the computer 110 through the interface 111 so as to be communicatable.

The scanner 120 is an apparatus for acquiring information on colors (hereinafter, referred to as color information) of an image by irradiating light to a document set in a document platen not shown in the figure, detecting reflected light thereof by using a sensor (for example, a CCD), not shown in the figure, which is included in a read-out carriage 121, and reading out the image of the document. This scanner 120 has a controller 125 that includes an interface 122, a CPU 123, and a memory 124. The scanner 120 transmits data representing the color information of an image through the interface 122 toward the scanner driver of the computer 110.

### <Configuration of Printer 1>

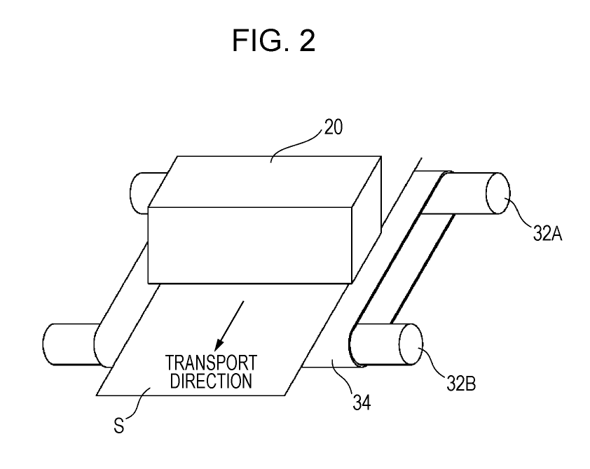

Next, the configuration of the printer 1 will be described with reference to FIGS. 1 and 2. FIG. 2 is a perspective view for describing a transport process and a dot forming process in the printer 1.

The printer 1, as shown in FIG. 1, includes a head unit 20, a transport unit 30, a detector group 40, and a controller 50. When the printer 1 receives print data from the computer 110, the controller 50 controls each unit (the head unit 20 and the transport unit 30) based on the print data so as to print an image on a printing medium. The state of the inside of the printer 1 is monitored by the detector group 40. The detector group 40 outputs a signal on the basis of the detection result toward the controller 50.

The head unit 20 is used for ejecting ink on a paper sheet S. The head unit 20 forms dots on a paper sheet S by ejecting ink onto the paper sheet S that is in the process of transport, and whereby an image is printed on the paper sheet S. The printer 1 according to this embodiment is a line printer, and the head unit 20 can form dots corresponding to the paper width at once.

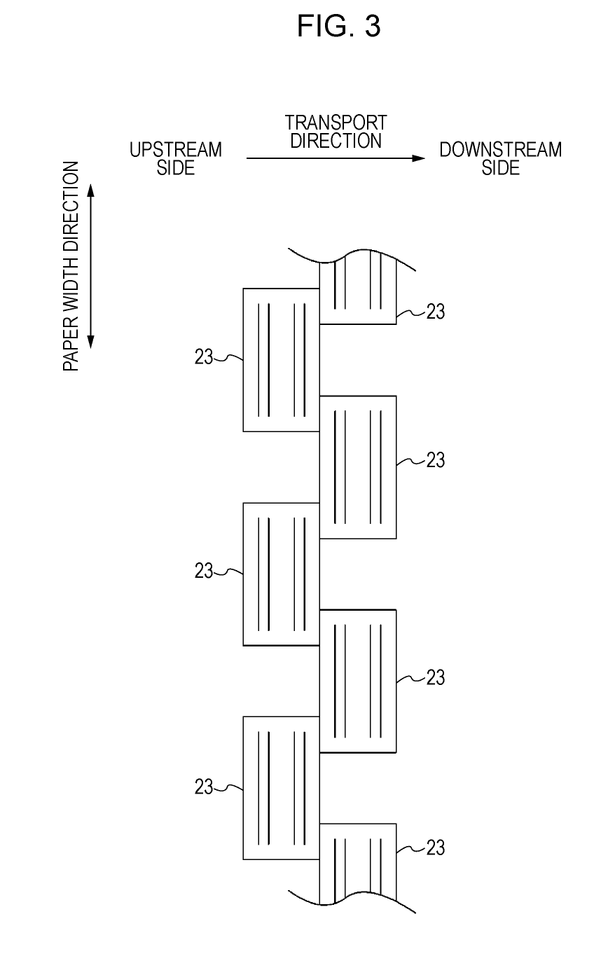

FIG. 3 is an explanatory diagram of the arrangement of a plurality of heads on the lower face of the head unit 20. As shown in the figure, a plurality of heads 23 is aligned in a zigzag pattern along the paper width direction. In each head, although not shown in the figure, a black ink nozzle row, a cyan ink nozzle row, a magenta ink nozzle row, and a yellow ink nozzle row are formed. Each nozzle row includes a plurality of nozzles that ejects ink. The plurality of nozzles of each nozzle row is aligned at a constant nozzle pitch along the paper width direction.

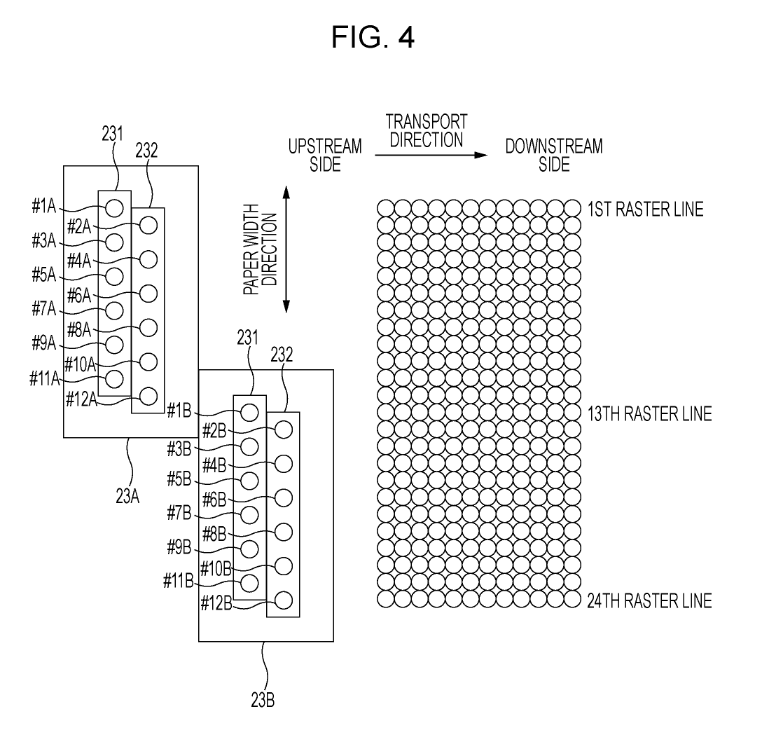

FIG. 4 is an explanatory diagram for briefly describing the disposition of the heads and appearance of dot formation. For the simplification of description, it is assumed that the head unit 20 to be described later is configured by two heads (a first head 23A and a second head 23B). In addition, for the simplification of description, it is assumed that only a yellow ink nozzle row is disposed in each head. In addition, for the simplification of description, it is assumed that the yellow ink nozzle row of each head has 12 nozzles. Here, a row of dots that are aligned in a direction in which the head and the paper sheet relatively move is referred to as a “raster line”. In a line printer as in this embodiment, a “raster line” means a row of dots that are aligned in the transport direction of a paper sheet. On the other hand, in a serial printer that performs a printing operation by using a head that is mounted on a carriage, a “raster line” means a row of dots that are aligned in the moving direction of the carriage. By aligning a plurality of the raster lines in a direction perpendicular to the moving direction, a print image is formed. As shown in the figure, a raster line that is located in the n-th position is referred to as the “n-th raster line”.

The yellow ink nozzle row of each head includes a first nozzle group 231 and a second nozzle group 232. Each nozzle group is configured by six nozzles that are aligned in the paper width direction at the pitch of 1/180 inch. The first nozzle group 411 and the second nozzle group 412 are formed so as to be deviated by 1/360 inch in the paper width direction. Accordingly, the yellow ink nozzle row of each head is a nozzle row that is configured by 12 nozzles that are aligned at the pitch of 1/360 inch in the paper width direction. To the nozzle row of each head, numbers are assigned orderly from the upper side in the figure.

By intermittently ejecting ink droplets from each nozzle onto a paper sheet S that is in the process of transport, each nozzle forms 24 raster lines on a paper sheet. For example, a nozzle #1A of the first head 23A forms a first raster line on the paper sheet, and a nozzle #1B of the second head 23B forms a 13th raster line on the paper sheet. Each raster line is formed along the transport direction.

The transport unit 30 is used for transporting a medium (for example, a paper sheet S or the like) in the transport direction. This transport unit 30 includes an upstream roller 32A, a downstream roller 32B, and a belt 34. When a transport motor not shown in the figure rotates, the upstream roller 32A and the downstream roller 32B rotate, and thereby the belt 34 rotates. A fed paper sheet S is transported up to a printable area (an area facing the head) by the belt 34. By transporting the paper sheet S by using the belt 34, the paper sheet S moves in the transport direction with respect to the head unit 20. The paper sheet S that passes through the printable area is discharged externally by the belt 34. In addition, the paper sheet S that is in the process of transport is electrostatically-adsorbed or vacuum-adsorbed to the belt 34.

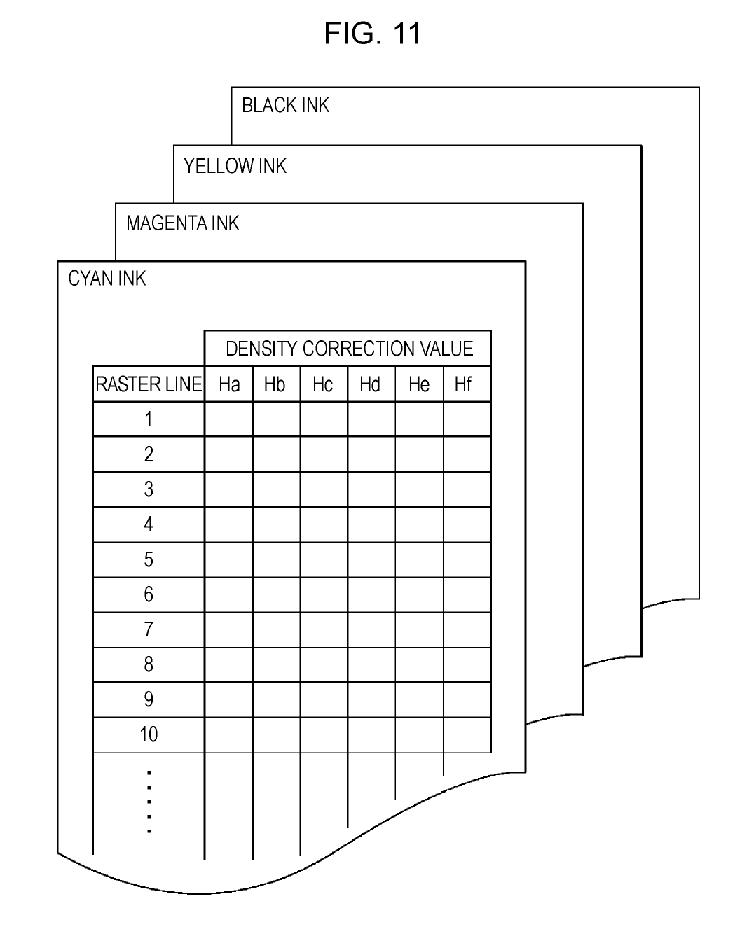

The controller 50 controls each unit of the printer 1 through the unit control circuit 54 by using the CPU 52. In addition, the printer 1 includes a memory 53 having a memory element. In the memory 53, a density correction value H is stored (see FIG. 11). The density correction value H will be described later.

### <Printing Process>

In such a printer 1, when the controller 50 receives the print data, the controller 50, first, rotates a feed roller (not shown in the figure) by using the transport unit 30 so as to transport the paper sheet S to be printed on the belt 34. The paper sheet S is transported at a constant speed on the belt 34 without stopping and passes below the head unit 20. During a period in which the paper sheet S passes below the head unit 20, ink is intermittently ejected from the nozzles of the first head 23A and the second head 23B. In other words, a process for forming dots and a process for transporting a paper sheet S are performed simultaneously. As a result, a dot row that is formed of a plurality of dots along the transport direction and the paper width direction is formed on the paper sheet S, and whereby an image is printed. Then, finally, the controller 50 discharges the paper sheet S for which an image printing process has been completed.

### <Overview of Process Performed by Printer Driver>

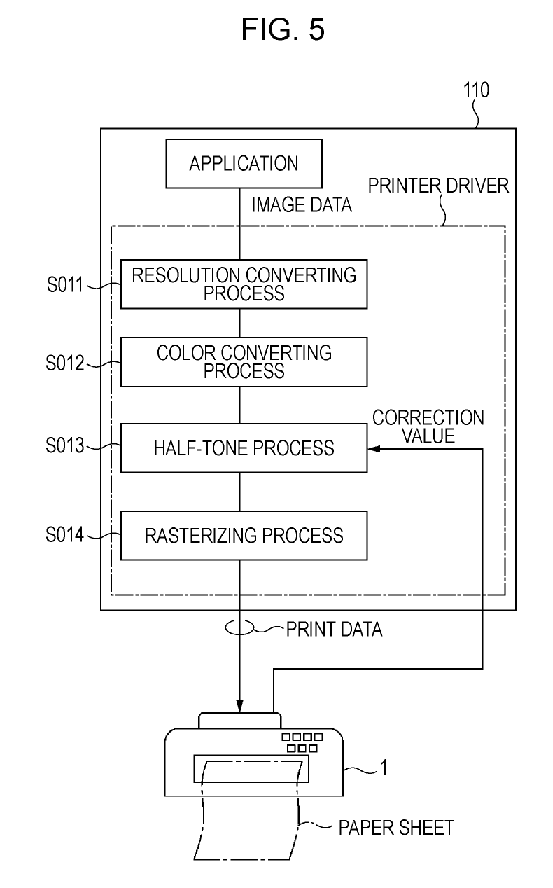

The above-described printing process, as described above, is started by transmission of the print data from the computer 110 that is connected to the printer 1. The print data is generated by a process performed by the printer driver. Hereinafter, a process performed by the printer driver will be described with reference to FIG. 5. FIG. 5 is an explanatory diagram showing the process performed by the printer driver.

The print data, as shown in FIG. 5, is generated by a resolution converting process (S011), a color converting process (S012), a half-tone process (S013), and a rasterizing process (S014) that are performed by the printer driver.

First, in the resolution converting process, the resolution of RGB image data that is acquired by executing the application program is converted into the print resolution corresponding to a designated image quality. Next, in the color converting process, the RGB image data of which the resolution is converted is converted into CMYK image data. Here, the CMYK image data represents image data of cyan (C), magenta (M), yellow (Y), and black (K) colors. Each of a plurality of pixel data that constitutes the CMYK image data is represented by gray scale values of 256 levels. This gray scale value is determined based on the RGB image data and is also referred to as a directed gray scale value.

Next, in the half-tone process, gray scale values of multiple levels represented by pixel data that constitutes the image data are converted into dot gray scale values of smaller levels that can be represented by the printer 1. In other words, the gray scale values of 256 levels that are represented by the pixel data are converted into the dot gray scale values of four levels. In particular, the gray scale values of 256 levels are converted into four levels of formation of no dot corresponding to a dot gray scale value [00], formation of a small dot corresponding to a dot gray scale value [01], formation of a medium dot corresponding to a dot gray scale value [10], and formation of a large dot corresponding to a dot gray scale value [11]. Thereafter, after a dot generation rate for each dot size is determined, image data is generated such that the printer 1 forms dots in a scattered manner by using a dither method, a γ correction method, an error diffusion method, or the like.

Next, in the rasterizing process, the order of data of dots (data of dot gray scale values) for the image data that is acquired by performing the half-tone process is changed to the order in which data is transmitted to the printer 1. Then, the data for which the rasterizing process has been performed is transmitted as a part of the print data.

### Suppression of Non-uniformity of Density

Next, non-uniformity of density occurring in an image that is printed by using the printer 1 and a method of suppressing the non-uniformity of density will be described.

### <Non-uniformity of Density>

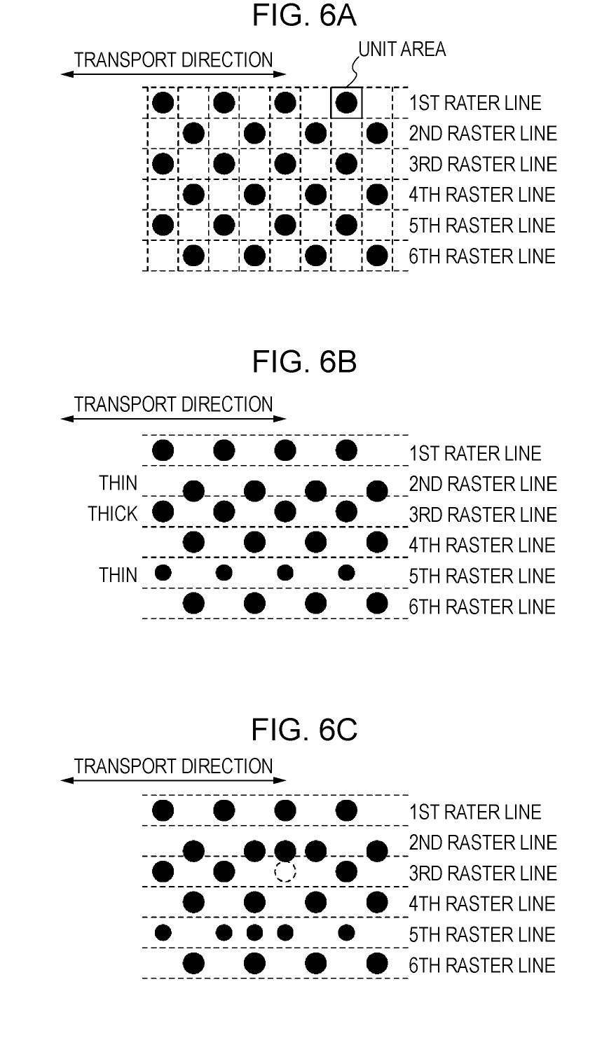

First, the non-uniformity of density will be described with reference to FIGS. 6A and 6B. FIG. 6A is a diagram showing a form for a case where the raster lines are formed ideally. FIG. 6B is a diagram showing a form for a case where non-uniformity of density occurs. Hereinafter, for the simplification of description, a case where the non-uniformity of density occurs in an image that is printed in monochrome will be described as an example.

When dots are correctly formed in unit areas by landing ink (ink droplets) of a predetermined amount ejected from nozzles in ideal positions, as shown in FIG. 6A, non-uniformity of density of the raster lines does not occur.

However, actually, there is a case where ink droplets land in positions deviated from ideal landing positions due to unbalance of accuracy of nozzle processing or the like. In the example shown in FIG. 6B, the second raster line is formed so as to be brought near the third raster line side. As a result, the density of the second raster line becomes relatively low, and the density of the third raster line become relatively high. In addition, in the example shown in the figure, the amount of ink ejected toward the fifth raster line is small, and accordingly, dots that constitute the fifth raster line are small. As a result, the density of the fifth raster line becomes relatively low. When the above-described phenomenon is viewed macroscopically, the non-uniformity of density of band shapes along the transport direction (so-called bending) is recognized visually. Such non-uniformity of density causes deterioration of the image quality of a printed image.

### <Method of Suppressing Non-uniformity of Density>

As a method of suppressing the above-described non-uniformity of density, performing correction of gray scale values (directed gray scale values) of pixel data can be considered. In other words, for forming a rater line, which can be easily recognized visually to be dark (light), to be lighter (darker), gray scale values of pixel data corresponding to the unit areas constituting the raster line are corrected. Accordingly, density correction values H that are used for correcting gray scale values of the pixel data for each raster line are calculated. These density correction values H are values on which the non-uniform characteristics of the printer 1 are reflected.

When the density correction values H for the raster lines are calculated, a process for correcting the gray scale values of the pixel data for each raster line is performed based on the density correction values H by the printer driver at the time when the half-tone process is performed. When each raster line is formed in accordance with the gray scale values corrected by the correction process, the density of the raster line is corrected. Accordingly, as shown in FIG. 6C, occurrence of non-uniformity of density in the printed image is suppressed. FIG. 6C is a diagram showing a form in which the occurrence of the non-uniformity of density is suppressed.

### <Calculation of Density Correction Value H>

Next, a process for calculating the density correction values H for each raster line (hereinafter, also referred to as a correction value acquiring process) will be overviewed. The correction value acquiring process, for example, is performed under a correction value calculating system 200 in a test line of a manufacturing factory of the printer 1. The correction value calculating system is a system for calculating the density correction values H according to the non-uniform density characteristics of the printer 1 and has a configuration that is approximately the same as the above-described printing system 100. In other words, the correction value calculating system includes a printer 1, a computer 110, and a scanner 120 (for the convenience of description, same reference signals as those of the printing system 100 are used). The correction value calculating system according to this embodiment corresponds to a correction value calculating device. In addition, the printer 1 corresponds to a correction pattern forming unit, the scanner 120 corresponds to a correction pattern reading unit, and the computer 110 corresponds to a correction value calculating unit.

The printer 1 is a target device for acquiring the correction values. In order to print an image without non-uniformity of density by using the printer 1, the density correction values H for the printer 1 are calculated in the correction value acquiring process. The configuration of the printer 1 and the like are described as above, and thus, a description thereof is omitted here. To the computer 110 that is placed in the test line, a correction value calculating program for allowing the computer 110 to perform the correction value acquiring process is installed.

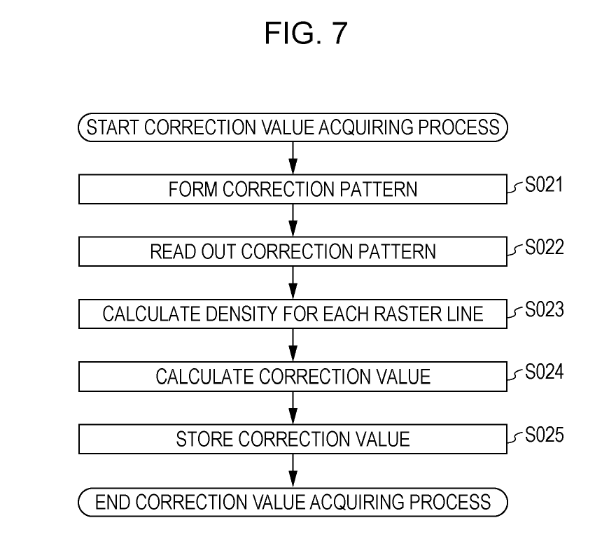

Hereinafter, the order of the correction value acquiring process will be described schematically with reference to FIG. 7. FIG. 7 is a diagram showing the flow of the correction value acquiring process. In a case where a printer 1 that can print multiple colors is used as the target, the correction value acquiring process for each color of ink is performed in a same order. In description below, the correction value acquiring process for one color of ink (for example, a yellow color) will be described.

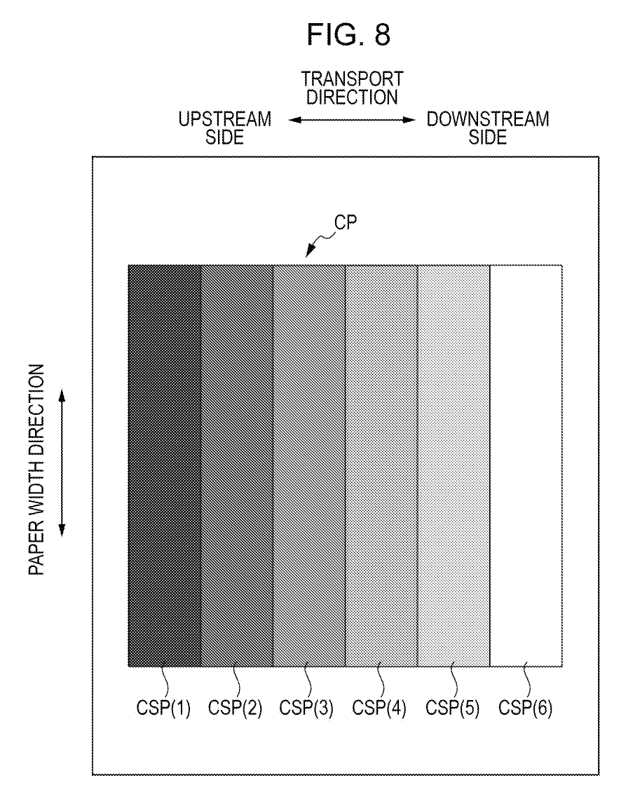

First, the computer 110 transmits print data to the printer 1, and the printer 1 forms a correction pattern CP on a paper sheet S in the order of the above-described printing operation (Step S021). This correction pattern CP, as shown in FIG. 8, is formed of sub patterns CSP of six density types. FIG. 8 is an explanatory diagram of the correction pattern CP.

Each sub pattern CSP is a band-shaped pattern. Each sub pattern CSP is configured by aligning a plurality of the raster lines, which is arranged in the transport direction, in the paper width direction. In addition, each sub pattern CSP is generated from image data of a specific gray scale value (directed gray scale value). In FIG. 8, the density becomes lower sequentially in the order from the sub pattern CSP that is located on the left side. In addition, the directed gray scale values of the sub patterns of these six types are denoted by symbols of Sa (=63), Sb (=137), Sc (=182), Sd (=207), Se (=232), and Sf (=255) (numbers in the parentheses represent corresponding gray scale values). For example, the sub pattern CSP that is formed in accordance with the directed gray scale value Sa, as shown in FIG. 8, is denoted by CSP(1). Similarly, the sub patterns CSP that are formed in accordance with the directed gray scale values Sb, Sc, Sd, Se, and Sf are denoted by CSP(2), CSP(3), CSP(4), CSP(5), and CSP(6).

Next, a tester sets the paper sheet S on which the correction pattern CP is formed in the scanner 120. Then, the computer 110 allows the scanner 120 to read out the correction pattern CP and acquires the result (Step S022). The scanner 120, for example, has three sensors corresponding to R (a red color), G (a green color), and B (a blue color). The scanner 120 irradiates light to the correction pattern CP and detects reflected light thereof by using the sensors. Then, the scanner 120 acquires a read-out gray scale value of R (hereinafter, also referred to as red color information), a read-out gray scale value of G (hereinafter, also referred to as green color information), and a gray scale value of B (hereinafter, referred to as blue color information).

Next, the computer 110 calculates the densities of raster lines of each sub pattern CSP based on the read-out gray scale values that are acquired by the scanner 120 (Step S023). Hereinafter, the density that is calculated based on the read-out gray scale value is also referred to as a calculated density. In addition, according to this embodiment, color information that is used for calculating the calculated density for each color of ink is configured to be selected from red, green, blue, and gray colors. For example, when the color of ink is yellow, the calculated density is acquired based on the blue color information. The reason for this will be described later.

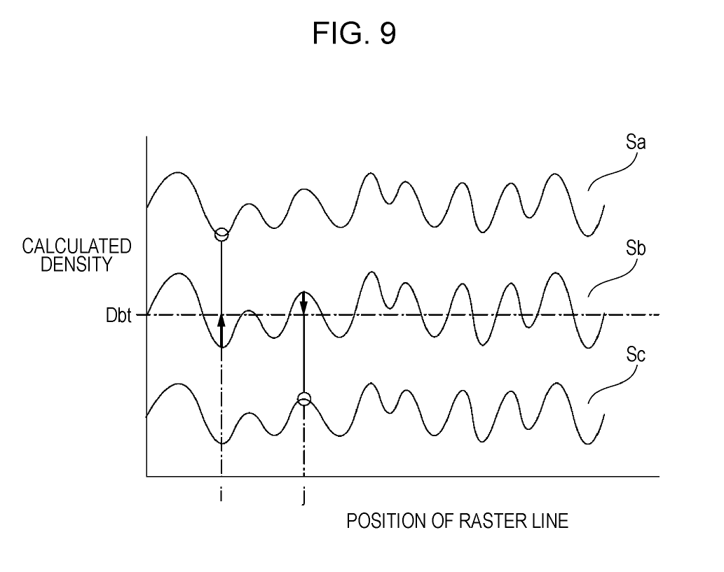

FIG. 9 is a graph showing the calculated densities for the raster lines of sub patterns CSP of which directed gray scale values are Sa, Sb, and Sc. In FIG. 9, the horizontal axis denotes the position of a raster line, and the vertical axis denotes the magnitude of the calculated density. As shown in FIG. 9, although each sub pattern CSP is formed in accordance with a same directed gray scale value, shading is generated in the raster lines. A difference in the shading of the raster lines causes the non-uniform density of a printed image.

Next, the computer 110 calculates density correction value H for each raster line (Step S024). In addition, the density correction values H are calculated for each directed gray scale value. Hereinafter, the density correction values H calculated for the directed gray scales Sa, Sb, Sc, Sd, Se, and Sf are denoted by Ha, Hb, Hc, Hd, He, and Hf. For describing the sequence for calculating the density correction values H, the sequence for calculating density correction values Hb that are used for correcting the directed gray scale values Sb such that the calculated densities for the raster lines of the sub pattern CSP(2) of the directed gray scale value Sb become constant will be described as an example. In the sequence, for example, an average value Dbt of the calculated densities of all the raster lines of the sub pattern CSP(2) of the directed gray scale value Sb is set as the target density of the directed gray scale value Sb. In FIG. 9, for an i-th raster line for which the calculated density is lower than the target density Dbt, correction is made such that the directed gray scale value Sb becomes higher. On the other hand, for a j-th raster line for which the calculated density is higher than the target density Dbt, correction is made such that the directed gray scale value Sb becomes lower.

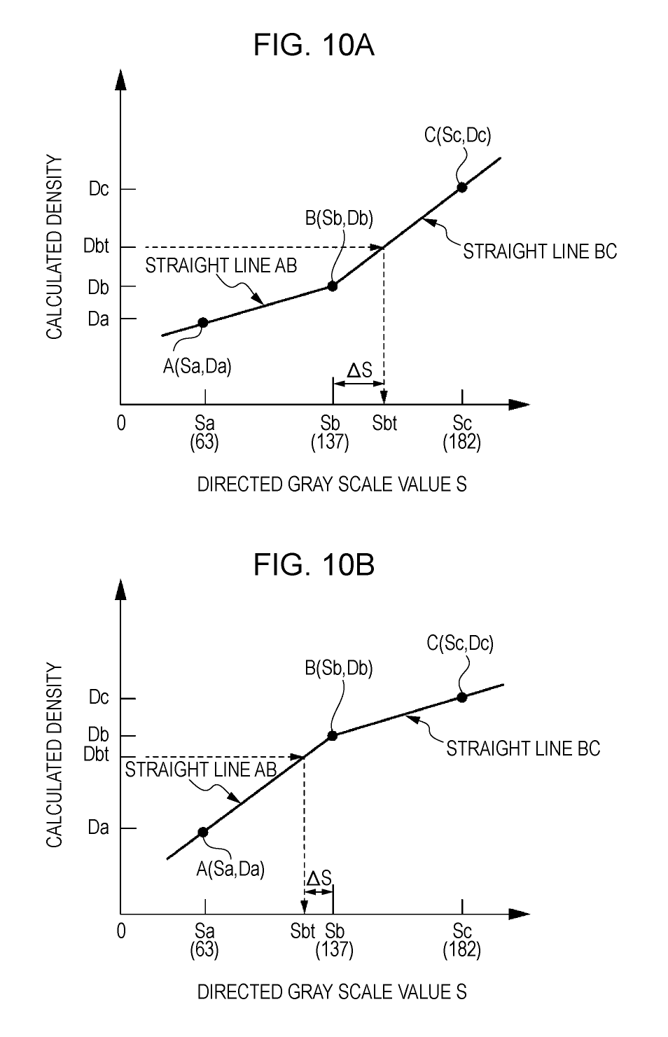

FIG. 10A is an explanatory diagram for the sequence for calculating the density correction value Hb that is used for correcting the directed gray scale value Sb of the i-th raster line. In addition, FIG. 10B is an explanatory diagram for the sequence for calculating the density correction value Hb that is used for correcting the directed gray scale value Sb of the j-th raster line. In FIGS. 10A and 10B, the horizontal axes denote the magnitude of the directed gray scale value, and the vertical axes denote the calculated density.

The density correction value Hb for the directed gray scale value Sb of the i-th raster line is calculated based on a calculated density Db of the i-th raster line of the sub pattern CSP(2) of the directed gray scale value Sb shown in FIG. 10A and a calculated density Dc of the i-th raster line of the sub pattern CSP(3) of the directed gray scale value Sc. In particular, in the sub pattern CSP(2) of the directed gray scale value Sb, the calculated density Db of the i-th raster line is lower than the target density Dbt. In other words, the density of the i-th raster line is lower than the average density. When the i-th raster line is desired to be formed such that the calculated density Db of the i-th raster line is the same as the target density Dbt, as shown in FIG. 10A, a gray scale value of pixel data corresponding to the i-th raster line, that is, the directed gray scale value Sb is corrected up to a target directed gray scale value Sbt that is calculated by using the following Equation (1) by using linear approximation based on the correspondence relationship (Sb, Db) and (Sc, Dc) of the directed gray scale value and the calculated density of the i-th raster line.

Sbt=Sb+(Sc−Sb)×{(Dbt−Db)/(Dc−Db)} Equation (1)

Then, a density correction value H for correcting the directed gray scale value Sb of the i-th raster line is acquired by using the following Equation (2) based on the directed gray scale value Sb and the target directed gray scale value Sbt.

Hb=ΔS/Sb=(Sbt−Sb)/Sb Equation (2)

On the other hand, the density correction value Hb for the directed gray scale value Sb of the j-th raster line is calculated based on the calculated density Db of the j-th raster line of the sub pattern CSP(2) of the directed gray scale value Sb shown in FIG. 10B and a calculated density Da of the j-th raster line of the sub pattern CSP(l) of the directed gray scale value Sa. In particular, in the sub pattern CSP(2) of the directed gray scale value Sb, the calculated density Db of the j-th raster line is higher than the target density Dbt. When the j-th raster line is desired to be formed such that the calculated density Db of the j-th raster line is the same as the target density Dbt, the directed gray scale value Sb of the j-th raster line, as shown in FIG. 10B, is corrected up to the target directed gray scale value Sbt that is calculated by using the following Equation (3) by using linear approximation based on the correspondence relationship (Sa, Da) and (Sb, Db) of the directed gray scale value and the calculated density of the j-th raster line.

Sbt=Sb+(Sb−Sa)×{(Dbt−Db)/(Db−Da)} Equation (3)

Then, by using the above-described Equation (2), the density correction value Hb that is used for correcting the directed gray scale value Sb for the j-th raster line is acquired.

As described above, the computer 110 calculates the density correction values Hb for the directed gray scale value Sb for each raster line. Similarly, the density correction values Ha, Hc, Hd, He, and Hf for the directed gray scale values Sa, Sc, Sd, Se, and Sf are calculated for each raster line. In addition, for other colors of ink, the density correction values Ha, Hc, Hd, He, and Hf for the directed gray scale values Sa to Sf are calculated for each raster line.

Thereafter, the computer 110 transmits data of the density correction values H to the printer 1 for storing the data of the density correction values in the memory 53 of the printer 1 (Step S025). As a result, in the memory 53 of the printer 1, a correction value table in which the density correction values H for six directed gray scale values Sa to Sf are arranged for each raster line is generated. FIG. 11 is a diagram showing the correction value table that is stored in the memory 53.

In addition, as shown in FIG. 11, correction tables are generated for each color of ink. Thus, the correction value tables for four colors of CMYK are formed. These correction value tables are referred to by the printer driver for correcting gray scale values of each raster line constituting image data of an image at a time when the image is printed by using the printer 1.

After the correction value acquiring process is completed, the printer 1 goes though other test processes. Then, the printer 1 is wrapped and shipped. When an image is printed by a purchaser (user) of the printer 1, an image having density that is corrected based on the density correction values H is printed.

For example, the printer driver of the user's computer 110 corrects the gray scale value (hereinafter, the gray scale value before correction is denoted by Sin) of each pixel data based on the density correction value H of a raster line corresponding to the pixel data (hereinafter, the gray scale value after correction is denoted by Sout).

In particular, when a gray scale value Sin of a raster line is the same as any one of the directed gray scale values Sa, Sb, Sc, Sd, Se, and Sf, the density correction value H that is stored in the memory of the computer 110 can be directly used. For example, when the gray scale value of the pixel data Sin=Sb, the correction value after correction Sout can be acquired by using the following equation.

Sout=Sb×(1+Hb)

On the other hand, when the gray scale value of the pixel data is different from the directed gray scale values Sa, Sb, Sc, Sd, Se, and Sf, a correction value is calculated based on interpolation using the density correction values of adjacent directed gray scale values. For example, in a case where the directed gray scale value Sin is between the directed gray scale value Sb and the directed gray scale value Sc, when a correction value that is acquired by performing linear interpolation using the density correction value Hb of the directed gray scale value Sb and the density correction value Hc of the directed gray scale value Sc is denoted by H′, a gray scale value after correction Sout of the directed gray scale value Sin can be acquired by using the following equation.

Sout=Sin×(1+H′)

In this way, the density correcting process for each raster line is performed.

### Selection of Color Information

### Reference Example

The scanner 120 reads out an image, for example, by moving a line sensor (for example, a CCD sensor), which is arranged in the main scanning direction, in the sub scanning direction. This line sensor, for example, includes a sensor for detecting light of a red color (R), a sensor for detecting light of a green color (G), and a sensor for detecting light of a blue color (B). The scanner 120 acquires three types of color information (read-out gray scale values) of the red color (R), the green color (G), and the blue color (B) by irradiating light onto a document and detecting (color-decomposing) reflected light thereof by using the sensors. This color information is transmitted to the computer 110 so as to be used for calculating the density correction value H.

Generally, in the computer 110, when Step S023 for acquiring the calculated densities of each ink is performed, gray color information is used regardless of the type of ink. Here, the gray color information is an average [(R+G+B)/3] of the types of the color information of the red color (R), the green color (G), and the blue color (B). In other words, the calculated density and the density correction value H of each sub pattern CSP are acquired based on the magnitude of the gray color information.

However, as described later, characteristics of read-out gray scale values that are acquired for colors of ink are different from one another. For example, when the gray color information is used, a change in the read-out gray scale value for the directed gray scale value may be decreased depending on the type (color) of ink. For example, yellow ink has low reactivity of the gray color information (read-out gray scale value) for a change in the amount of ejection of ink (directed gray scale value). In other words, the amount of change in the gray color information that is acquired from sub patterns CSP of the yellow correction pattern CP is small. In such a case, the density correction value H can be easily influenced by an error (hereinafter referred to as a read-out error) at the time when a read-out operation is performed by the scanner 120, and accordingly, the accuracy of the density correction value H may be decreased. Therefore, according to the following embodiment of the invention, the accuracy of the density correction value H is improved by selecting color information that is appropriate for each color of ink.

### Embodiments of the Invention

As described in the above-described reference example, when the change in the read-out gray scale value for the change of the directed gray scale value is small, the influence of the read-out error can be easily received. In other words, as the amount of change in the read-out gray scale value for the change of the directed gray scale value becomes larger, the influence of the read-out error cannot be easily received.

Accordingly, in this embodiment, the amounts of changes in information of each color (the red color, the green color, the blue color, and the gray color) that are acquired by reading out the sub patterns CSP of each directed gray scale value for the types of ink are compared to one another, and color information having a largest difference (hereinafter, also referred to as a dynamic range) between a maximum value and a minimum value of read-out gray scale values for each color of ink is selected so as to be used.

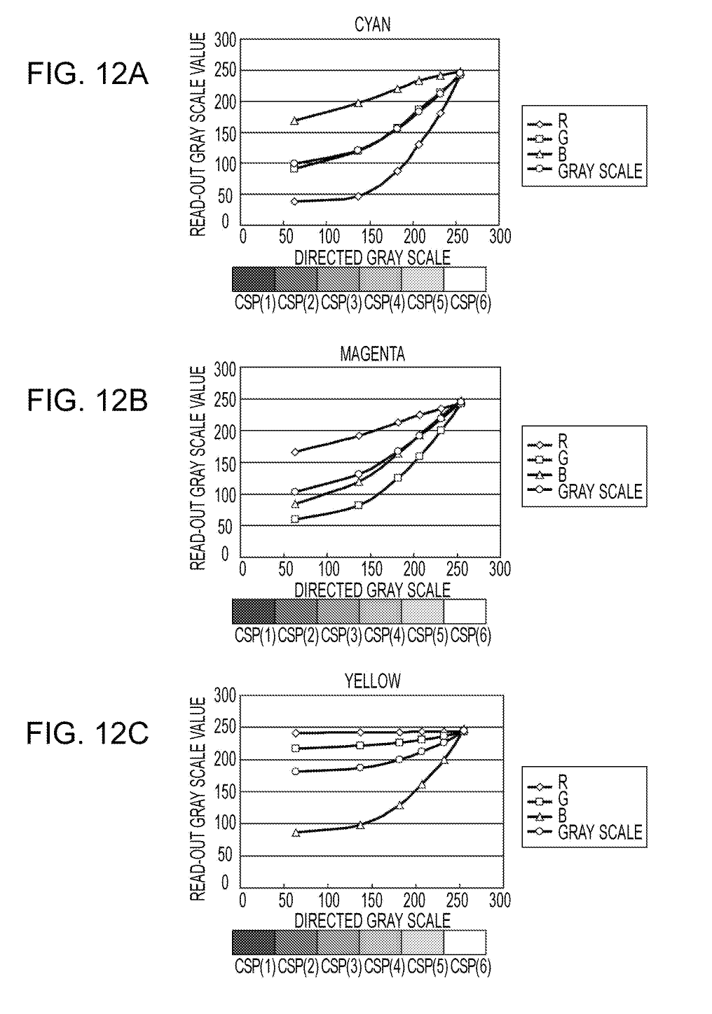

FIGS. 12A to 12C are diagrams showing relationship between the gray scale of the correction pattern CP and the read-out result of the scanner 120. FIG. 12A is a diagram showing the read-out result of the correction pattern CP of the cyan color. In addition, FIG. 12B is a diagram showing the read-out result of the correction pattern CP of the magenta color, and FIG. 12C is a diagram showing the read-out result of the correction pattern CP of the yellow color. In FIGS. 12A to 12C, the horizontal axes represent the magnitude of the gray scale (directed gray scale value) of the correction pattern CP, and the vertical axes represent the magnitude of the read-out gray scale value. Each point in the figures represents an average value of read-out gray scale values of raster lines of each sub pattern CSP.

As a sub pattern CSP of the correction pattern CP is located toward the left side in the figure, the color of the sub pattern CSP becomes darker, and as a sub pattern CSP of the correction pattern CP is located toward the right side, the color of the sub pattern CSP becomes lighter. For example, CSP(1) is the darkest color, and CSP(6) is the lightest color. As the directed gray scale value of the sub pattern is higher (that is, the sub pattern is located toward the right side in the figure), the read-out gray scale values of R, G, and B have higher values.

In FIGS. 12A to 12C, relationship of magnitudes of read-out gray scale values of the red color, the green color, the blue color, and the gray color and inclinations of the gray scales are different for the colors of ink.

Here, when the color of ink is yellow (FIG. 12C), the dynamic ranges (a difference between a maximum value and a minimum value of read-out gray scale values) of the red color and the green color are very small. In other words, the change in the read-out gray scale value for the change of the directed gray scale is small. In other words, even when the amount of ejection (directed gray scale value) of the yellow ink is changed, a difference in the read-out gray scale values of the red color or the green color cannot occur easily. In addition, therefore, the dynamic range of the gray color that is an average of the R, G, and B is smaller than that of the cyan color (FIG. 12A) or the magenta color (FIG. 12B).

Accordingly, in such a case, when the gray color information is used for calculating the density correction value H, the influence of the read-out error of the scanner 120 can be received easily. Therefore, an accurate density correction value H may not be calculated.

Thus, according to this embodiment, the computer 110 selects one from among the types of color information of the red color, the green color, the blue color, and the gray color, which are acquired for each color of ink from the scanner 120, that has the largest dynamic range, and the density correction value H is calculated based on the selected color information.

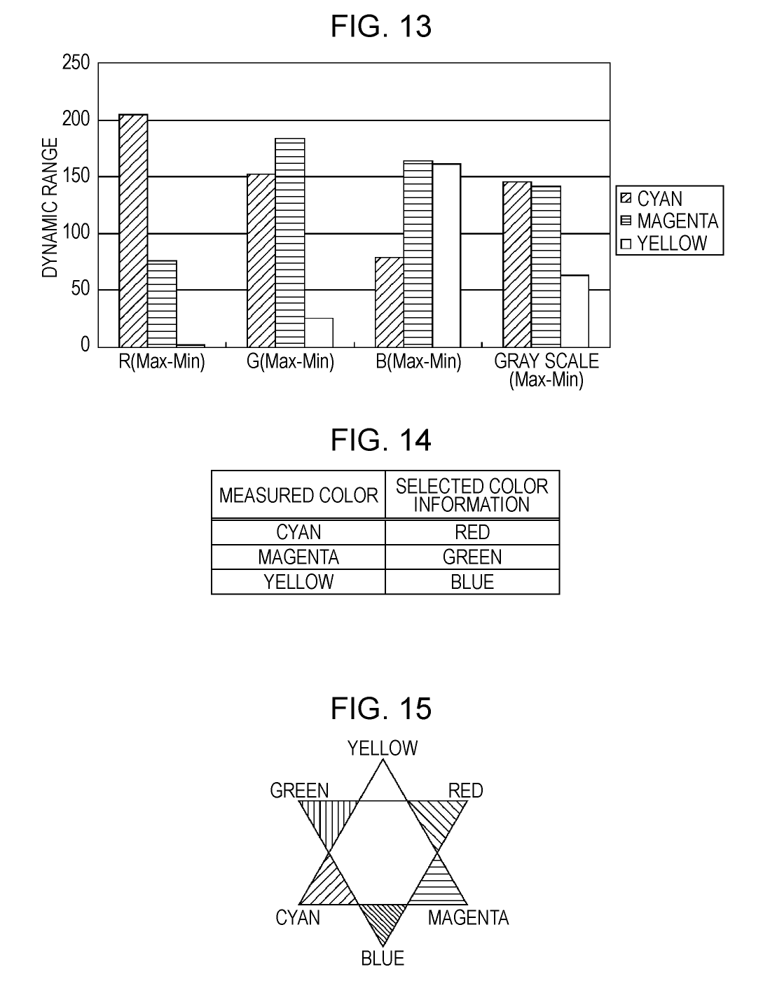

FIG. 13 is a diagram showing the relationship between the color of ink and the dynamic range of the color information of each of the red color, the green color, the blue color, and the gray color. Here, the vertical axis in FIG. 13 represents the size of the dynamic range. The dynamic ranges shown in FIG. 13 are acquired from FIGS. 12A to 12C.

In the order from the left side in the figure, a dynamic range of color information of the red color (R), a dynamic range of color information of the green color (G), a dynamic range of color information of the blue color (B), and a dynamic range of color information of the gray color (an average of R, G, and B) are shown for the colors (cyan, magenta, and yellow colors) of ink. For example, three graphs shown on the left side in the figure represent the dynamic range of the red color information, and in the order from the left side, there are dynamic ranges acquired by reading out the sub patterns CSP of a cyan correction pattern CP, a magenta correction pattern CP, and a yellow correction pattern CP.

In the figure, it can be found that the dynamic ranges of the red color information and the green color information are very small for the yellow color. In addition, the dynamic range of the color information of the gray color is quite smaller than those of the cyan color and the magenta color. Accordingly, when the gray color information is used for the yellow color, the change in the read-out gray scale value is small, and therefore the influence of the read-out error can be received easily. Thus, according to this embodiment, from among types of the color information, one that has the largest dynamic range is selected. For example, when the color of ink is yellow, the color information that has the largest dynamic range is the blue color information as shown in FIGS. 12C and 13. Accordingly, when calculating the density correction value H of the yellow color, the computer 110 selects the blue color information from among the types of the color information that are acquired from the scanner 120 based on the result and uses the blue color information. Then, the computer 110 calculates the density correction value H by acquiring the calculated density of the correction pattern CP of the yellow color based on the blue color information.

Similarly, as shown in FIG. 13, the computer 110 selects the red color information that has the largest dynamic range for the cyan color. In addition, the computer 110 selects the green color information that has the largest dynamic range for the magenta color.

FIG. 14 is a diagram showing correspondence relationship of each color of ink and the selected color information according to the first embodiment. As described above, the red color information is selected for the cyan color, the green color information is selected for the magenta color, and the blue color information is selected for the yellow color. The data representing this correspondence relationship, for example, is stored in the memory 113 of the computer 110. When the density correction value H is calculated, the computer 110 according to the first embodiment refers to the data shown in FIG. 14 for selecting the color information applied for each color of ink. Then, the computer 110 calculates calculated densities for each raster line of the corresponding correction pattern CP by using the selected color information (Step S023 shown in FIG. 7) and calculates the density correction value H based on the calculated densities (Step S024 shown in FIG. 7). In addition, all the color information that is selected in the first embodiment is configured to be a complementary color of each color of ink.

FIG. 15 is a diagram for describing complementary colors. The complementary colors are colors that are located in opposite positions in a color circle and are mixed to be an achromatic color. As shown in the figure, the complementary color of the cyan color is the red color, the complementary color of the magenta color is the green color, and the complementary color of the yellow color is the blue color.

As described above, as color information that is used at a time when the density correction value H is calculated by reading the correction pattern CP by using the scanner 120, color information that has the largest dynamic range is selected. Accordingly, the influence of the error at a time when a read-out operation is performed by the scanner 120 cannot be received easily, and thereby the calculated density of each sub pattern CSP of the correction pattern CP can be acquired more accurately. Therefore, the accuracy of the density correction value H can be improved.

In addition, when the color information having a small dynamic range is used, for example, the inclination of a straight line formed between the directed gray scale values shown in 10A is decreased. For example, in the straight line BC, a difference between the calculated density Dc and the calculated density Db is decreased. Accordingly, when an intersection of the reference calculated density Dbt and the straight line BC is to be acquired, variation can be generated easily. Accordingly, variation in ΔS shown in the figure can be generated easily, and thereby variation in the density correction value H can be generated easily. According to this embodiment, the color information having the largest dynamic range is used for each color of ink. Thus, for example, when linear approximation of the calculated density between the directed gray scale value Sb and the directed gray scale value Sc is performed for FIG. 10A described above, a difference ΔS between the directed gray scale value Sb and the target directed gray scale value Sbt can be calculated accurately. Accordingly, the variation at a time when the density correction value H is acquired can be suppressed.

### Second Embodiment

For example, in FIG. 12A, although the dynamic range of the read-out gray scale value of the red color is larger than those of the green color, the blue color, and the gray color, the read-out gray scale values for the CSP(1) and CSP(2) in which the directed gray scale values are low scarcely change. In other words, the amount of change (inclination) of the read-out gray scale values in two points described above is small. Thus, for example, when the red color information is selected for the cyan color, the influence of the error can be received easily on a side of a low gray scale value for the same reason as for the first embodiment.

Accordingly, according to the second embodiment, the amount of change of the read-out gray scale value for each adjacent sub pattern (hereinafter, also referred to as inclination of gray scales) is calculated, and a minimum value of the amounts of change for each color information is acquired. Then, the minimum values are compared to one another, and the color information that has the largest minimum value is selected. Accordingly, the color information that does not include a portion in which the influence of the error can be easily received locally can be selected, and thereby the accuracy of the density correction value H can be improved.

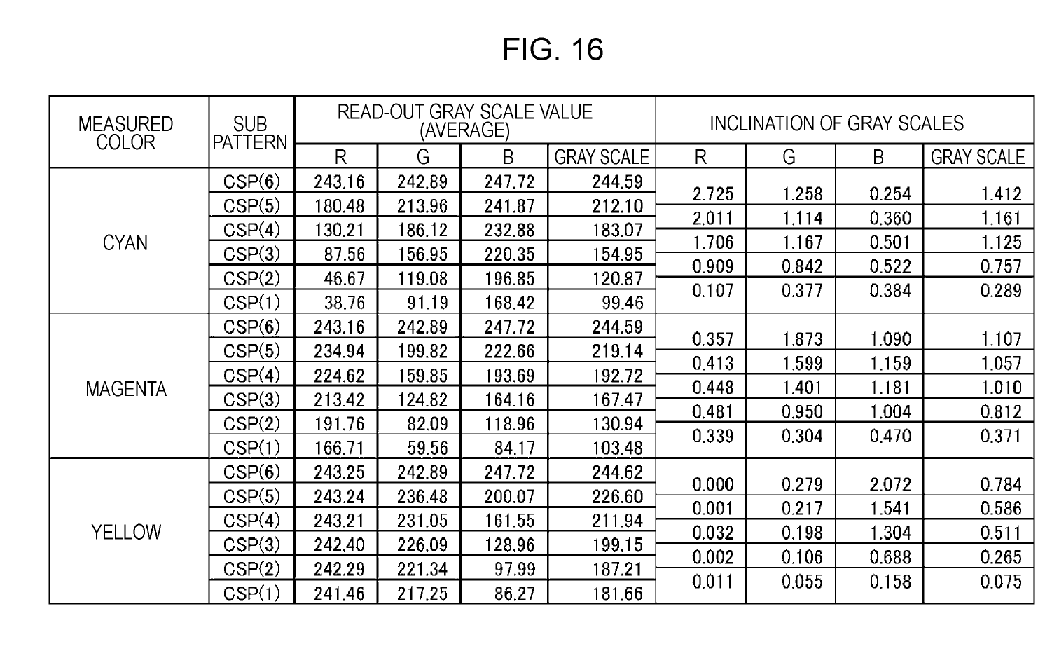

FIG. 16 is an explanatory diagram showing an example of color information of the red, green, and blue colors of each sub pattern CSP of the correction pattern CP and calculated results of inclinations of gray scales of each sub pattern. The computer 110 according to the second embodiment calculates the inclination of gray scales based on the color information that is acquired from the scanner 120. In addition, the inclination of the gray scales is the amount of change in the read-out gray scale values with respect to the amount of change of the directed gray scale value. For example, the inclination of the gray scales is inclination of two adjacent points shown in FIGS. 12A to 12C.

The left side in FIG. 16 represents the read-out gray scale values (average values of each raster line) of each sub pattern for each measured color. In addition, the right side in FIG. 16 represents the inclination of the gray scales of the sub patterns for each color information. For example, for each color information of each measured color, in the order from the upper side in the figure, inclination of gray scales of the sub patterns CSP(6) and CSP(5), inclination of gray scales of the sub patterns CSP(5) and CSP(4), inclination of gray scales of the sub patterns CSP(4) and CSP(3), inclination of gray scales of the sub patterns CSP(3) and CSP(2), and inclination of gray scales of the sub patterns CSP(2) and CSP(1) are shown.

For example, for a case where the measured color is the cyan color, the inclination of the gray scales of a sub pattern CSP(6) of a directed gray scale value Sf (=255) and a sub pattern CSP(5) of a directed gray scale value Se (=232) can be acquired by dividing a difference between the read-out gray scale value (243.16) of the sub pattern CSP(6) and the read-out gray scale value (180.48) of the sub pattern CSP(5) by a difference between the directed gray scale values (255-232). In other words, (243.16−180.48)/(255−232)=2.725. For other cases, the inclination of the gray scales is acquired in the same manner.

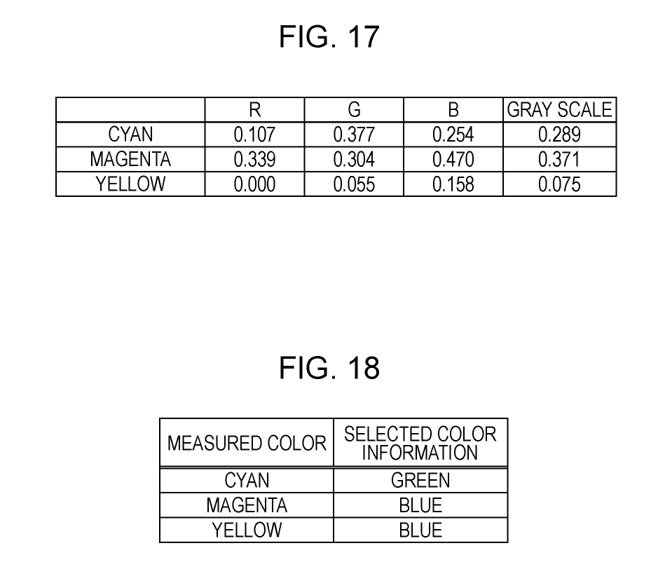

FIG. 17 is a diagram showing a smallest value (minimum value) of the color information (R, G, B, and gray) from among the inclinations of gray scales shown in FIG. 16.

For example, for the cyan color, the minimum value of the inclinations of gray scales of the red color information is 0.107, the minimum value of the inclinations of gray scales of the green color information is 0.377, the minimum value of the inclinations of gray scales of the blue color information is 0.254, and the minimum value of the inclinations of gray scales of the gray color information is 0.289. The computer 110 according to the second embodiment selects the color information of which the minimum value is the largest. For example, in FIG. 17, for the cyan color, the largest minimum value of the inclinations of gray scales is 0.377 of the green color.

In addition, for the magenta color, the largest minimum value of the inclinations of gray scales is 0.470 of the blue color information. For the yellow color, the largest minimum value of the inclinations of gray scales is 0.158 of the blue color information.

FIG. 18 is a diagram showing correspondence relationship between each color of ink and selected color information according to the second embodiment. In FIG. 18, according to the second embodiment, the green color information is selected for the cyan color, the blue color information is selected for the magenta color, and the blue color information is selected for the yellow color. The data representing this correspondence relationship, for example, is stored in the memory 113 of the computer 110. The computer 110 according to the second embodiment selects the color information to be applied for each color of ink for calculating the density correction value H by referring to the data shown in FIG. 18. Then, the computer 110 calculates the calculated density for each raster line of the corresponding correction pattern CP by using the selected color information (Step S023 shown in FIG. 7) and calculates the density correction value H based on the calculated density (Step S024 shown in FIG. 7).

As described above, by acquiring minimum values of the inclinations of gray scales and selecting the color information of which the minimum value is the largest, the color information that does not include a portion in which the change of the read-out gray scale value is locally small between the gray scales can be selected. For example, in FIG. 12A, the red color information of which the change of the read-out gray scale value is small on a side of a low directed gray scale value can be excluded.

Accordingly, the color information that does not include a portion in which the influence of the error can be received easily can be selected. As a result, the accuracy of calculation of the density correction value H can be improved.

### Third Embodiment

As described in the first embodiment, in order to calculate the density correction value H, it is preferable that the dynamic range of the read-out gray scale values is large (for example, the red color shown in FIG. 12A). However, for the case of FIG. 12A, the inclination of gray scales (hereinafter, also referred to as an inter-gray scale inclination) on a side of a low gray scale is decreased. In other words, for the case of FIG. 12A, a portion in which the inter-gray scale inclination is high and a portion in which the inter-gray scale inclination is low are mixed (the amount of change in the inter-gray scale inclination is large). Accordingly, the density correction value H can be acquired with high accuracy on a side of a high gray scale. However, on a side of a low gray scale, the influence of the read-out error can be received easily, and accordingly, the accuracy of the density correction value H may be decreased. In other words, the accuracy of the density correction value H is different for the side of a high gray scale and the side of a low gray scale.

On the other hand, in order to acquire constant accuracy for the gray scales in calculating the density correction value H, it is preferable that the inter-gray scale inclination is not changed (is constant) over all the gray scales. For example, when the change in the inter-gray scale inclination is small as for the blue color shown in FIG. 12A, the density correction value H can be calculated with constant accuracy for the gray scales. However, in such a case, the dynamic range is small, and the overall accuracy of calculation of the density correction value H may be decreased.

As described above, both a large dynamic range and a small amount of change in the inter-gray scale inclination are preferable. However, there may be a case where both the large dynamic range and the small amount of change in the inter-gray scale inclination cannot be implemented together. Thus, according to a third embodiment of the invention, indices in which priority is assigned to the dynamic range and the amount of change (a difference between a maximum value and a minimum value) in the inter-gray scale inclination are determined, and by comparing the indices, the color information to be applied is selected. In particular, weighted calculation is performed for the dynamic range and the amount of change in the inclination, and the color information to be selected is determined based on the result of the calculation.

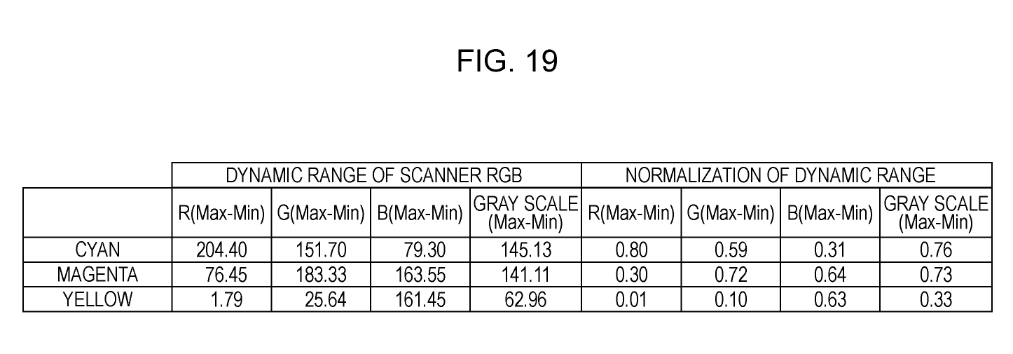

FIG. 19 is a diagram for describing the dynamic ranges of each color information and the normalization thereof. The left side in FIG. 19 shows the dynamic ranges of each color information. For example, when the measured color is the cyan color, a maximum value of the red color information is 243.16, and a minimum value of the red color information is 38.76 (see FIG. 16). Accordingly, the dynamic range of the red color information is 204.4 (=243.16−38.76). For other cases, the dynamic range is calculated in the same manner. In addition, color information for which the dynamic range becomes the maximum, as described above, is the red color information for the cyan color, is the green color information for the magenta color, and is the blue color information for the yellow color.

In addition, on the right side in FIG. 19, normalized values of the dynamic ranges on the left side in FIG. 19 are shown. A normalization process of the dynamic ranges is performed by dividing the calculated dynamic ranges by a maximum value (255) of the gray scale. For example, for a case where the measured color is the cyan color, the dynamic range of the red color is 204.4. Thus, when the dynamic range of the red color is normalized, 0.80 (=204.4/255) is acquired. For other cases, a normalized value is calculated in the same manner.

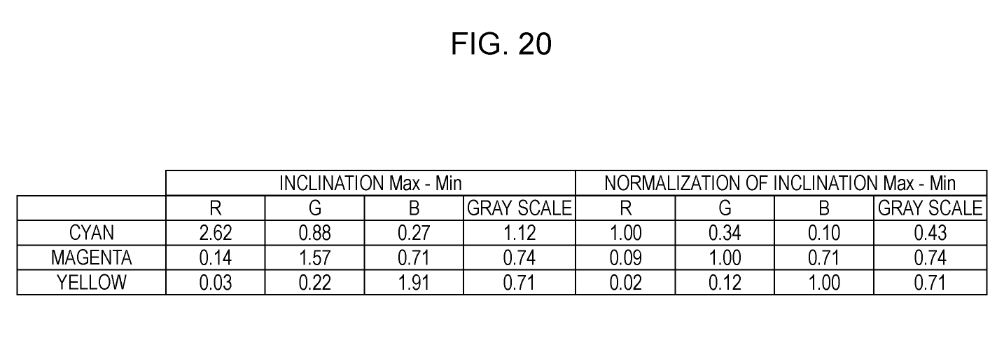

FIG. 20 is a diagram for describing the amount of change in the inter-gray scale inclination of each color information and the normalization thereof. The amount of change in the inter-gray scale inclination is a difference between a maximum value (max) of the inter-gray scale inclination and a minimum value (min) of the inter-gray scale inclination.

On the left side in FIG. 20, calculated results of the amounts of change in the inter-gray scale inclination of each color information are shown. For example, for a case where the measured color is the cyan color in FIG. 16, a maximum value of the inter-gray scale inclination of the red color is 2.725 between the sub patterns CSP(6) and CSP(5). In addition, a minimum value of the inter-gray scale inclination of the red color is 0.107 between the sub patterns CSP(2) and CSP(1). Accordingly, in such a case, the amount of change (a difference between a maximum value and a minimum value) in the inter-gray scale inclination is 2.62 (=2.725−0.107). For other cases, the amount of change in the inter-gray scale inclination is calculated in the same manner.

On the right side in FIG. 20, normalized values of the amounts of change in the inter-gray scale inclination are shown. A normalization process is performed by dividing the value of the amount of change in the inter-gray scale inclination of each color information by a maximum value of the color information.

For example, for the case of the cyan color, the amounts of change (max-min) in the inter-gray scale inclination of each color information of the red, green, blue, and gray colors, as shown on the left side in FIG. 20, are 2.62, 0.88, 0.27, and 1.12. Among these, a maximum value is 2.62 of the red color. Accordingly, the amount of change (max-min) in the inter-gray scale inclination is normalized by diving the above-described values by 2.62.

In addition, for the case of the magenta color, a maximum value of the amounts of change in the inter-gray scale inclination is 1.57 of the green color information. Accordingly, for the case of the magenta color, a normalization process is performed by dividing the amount of change (max-min) in the inter-gray scale inclination of each color information by 1.57.

In addition, for the case of the yellow color, a maximum value of the amount of change in the inter-gray scale inclination is 1.91 of the blue color information. Accordingly, for the case of the yellow color, a normalization process is performed by dividing the amount of change (max-min) in the inter-gray scale inclination of each color information by 1.91.

Then, the computer 110 according to the third embodiment performs weighted calculation based on the normalized dynamic ranges and the normalized amounts of change (max-min) in the inter-gray scale inclinations and selects the color information that has a maximum result. For example, when a value of the normalized dynamic range is denoted by A and the normalized value of the amount of change in the inter-gray scale inclination is denoted by B, a calculation equation with weights is the following Equation (4).

A×W₁+(1−B)×W₂ Equation (4)

Here, W₁ is a weighting factor of the dynamic range, and W₂ is a weighting factor of the amount of change in the inter-gray scale inclination. In this embodiment, it is configured that W₁=2 and W₂=1. In other words, the weighting factor of the dynamic range is larger than that of the amount of change in the inter-gray scale inclination.

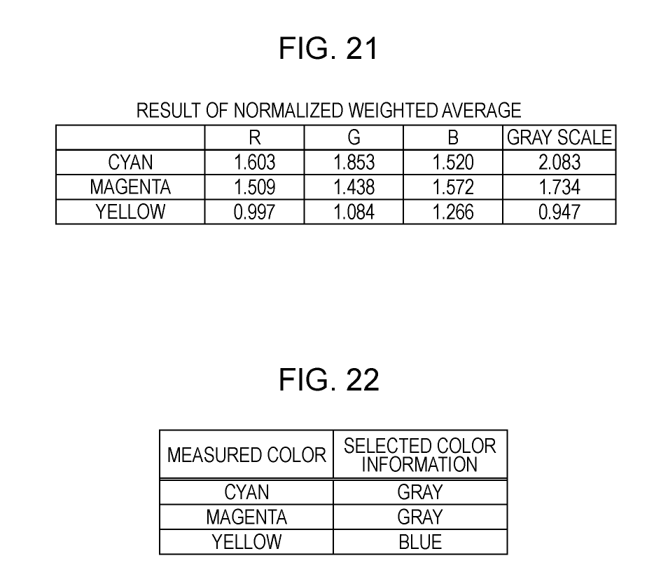

FIG. 21 is a diagram showing the result of weighted calculation. In the figure, for example, for the cyan color, 2.083 of the gray color is the maximum. In addition, for the magenta color, 1.734 of the gray color is the maximum. For the yellow color, 1.266 of the blue color is the maximum. [00138] FIG. 22 is a diagram showing correspondence relationship of each color of ink and the selected color information according to the third embodiment. As shown in the figure, for the cyan and magenta colors, the gray color information [(R+G+B)/3] is selected, and for the yellow color, the blue color information is selected. When calculating the density correction values H, the computer 110 according to the third embodiment selects the color information to be applied to each color of ink by referring to the data shown in FIG. 22. Then, the computer 110 calculates the calculated densities for the raster lines of the corresponding correction pattern CP (Step S023 shown in FIG. 7) and calculates the density correction values H based on the calculated densities (Step S024 shown in FIG. 7).

Accordingly, the color information can be selected in consideration of the amounts of change in the inclinations of gray scales and the dynamic ranges. Therefore, the density correction value H that has high accuracy with a little bias can be calculated. As a result, the accuracy of calculation of the density correction value H can be improved.

### Other Embodiments

As above, mainly, a correction value calculating apparatus relating to the invention has been described based on the above-described embodiments. However, in the description above, disclosure of a color information selecting system for performing selection of the color information and a program for allowing the computer 110 included in the color information selecting system to perform a color information selecting process is included. In addition, the above-described embodiments are not for the purpose of limiting the invention but for the purposes of easy understanding of the invention. It is apparent that the invention may be changed or modified without departing from the gist of the invention, and an equivalent thereof is included therein.

### <Printer 1>

In the above-described embodiments, a line head printer in which nozzles are aligned in the paper width direction intersecting the transport direction of the medium is exemplified. However, the invention is not limited thereto. For example, a printer that alternately repeats a dot forming operation for forming a dot row along a moving direction with the head unit moving in the moving direction intersecting the nozzle row direction and a transport operation (moving operation) for transporting a sheet in the transport direction that is the nozzle row direction may be used.

In the above-described embodiments, an ink jet printer that ejects ink as an example of liquid has been described. However, the invention is not limited thereto. Thus, the invention may be applied to a liquid ejecting apparatus that ejects liquid other than ink. For example, the invention may be applied to a coloring device for attaching shapes to a cloth, a display manufacturing apparatus such as a color filter manufacturing apparatus or an organic EL display, a DNA chip manufacturing apparatus that manufactures a DNA chip by coating a chip with a solution in which DNA is melt, a circuit board manufacturing apparatus, and the like. In addition, as a method of ejecting ink for ejecting ink from a nozzle of the printer 1, a piezo method in which an ink chamber is expanded or contracted by driving a piezo element or a thermal method in which air bubbles are generated inside a nozzle by using a heating element and ink is ejected by using the air bubbles may be used.

In addition, the printer 1 has been described as an ink jet printer. However, the invention can be applied to a printer that forms an image, for example, by using laser for correcting the density.

### <Scanner 120>

In the above-described embodiment, the scanner 120 of a sensor type in which sensors (for example, CCDs) of R, G, and B are included therein and the color information of R, G, and B is acquired by reading out reflected light of light irradiated onto a document by using the sensors has been described. However, the invention is not limited thereto. For example, a light source converting type in which fluorescent lamps of colors of R, G, and B are sequentially blinked and the color information of R, G, and B is acquired by reading out the reflected light by using a monochrome image sensor or a filter converting type in which color filters of R, G, and B are disposed between a light source and a sensor and the color information of R, G, and B is acquired by sequentially converting the color filters may be used.

### <Correction Pattern CP>

In the above-described embodiments, correction of density is performed in units of raster lines by using the correction pattern CP. However, the invention is not limited thereto. Thus, the invention may be applied to a case where correction of density is made by performing read-out of a correction pattern by using a scanner.

In addition, in the above-described embodiments, all the sub patterns CSP(1) to CSP(6) of the correction pattern CP are read out by the scanner. However, all the sub patterns need not to be read out. For example, changes in the gray scales of CSP(6) having the highest gray scale and CSP(1) having the lowest gray scale are not easily recognized based on the human's visual characteristics. Accordingly, the above-described embodiments may be performed by using sub patterns (for example, CSP(2) to CSP(5)) for the gray scales that are sensitive to human's visual characteristics.

What is claimed is:

1. A method of calculating a correction value, the method comprising:
forming a correction pattern on a medium in a yellow color;
acquiring blue color information by reading out the correction pattern; and
calculating a correction value of the density of the yellow color based on the blue color information.

2. The method according to claim 1,
wherein sub patterns of a plurality of gray scales of the yellow color are formed on the medium as the correction pattern in the forming of the correction pattern on the medium, and
wherein the blue color information is acquired for each of the sub pattern of the plurality of gray scales by reading out the correction pattern.

3. The method according to claim 2,
wherein the sub pattern of a specific gray scale and the sub pattern of a different gray scale are formed on the medium in the forming of the correction pattern on the medium, and
wherein a correction value of the density of the yellow color that is used for forming the specific gray scale is calculated based on the blue color information read out from the sub pattern of the specific gray scale and the blue color information read out from the sub pattern of the different gray scale, in the calculating of the correction value.

4. The method according to claim 1, wherein, the correction pattern is formed by liquid ejected from a plurality of nozzles, which is used for ejecting yellow liquid, of a head onto the medium in the forming of the correction pattern on the medium.

5. A liquid ejecting apparatus comprising a head in which a plurality of nozzles for ejecting yellow liquid is formed,
wherein an image is printed by correcting the correction pattern that is formed on the medium in the yellow color in accordance with a correction value of the density of the yellow color that is calculated based on blue color information acquired by being read out by the scanner.
